(19) United States
(12) Patent Application Publication
(10) Pub. No.: US 2025/0335654 A1
(43) Pub. Date: Oct. 30, 2025

(54) FIDELITY-GOVERNED MODELLING SYSTEMS AND METHODS IN SIMULATION FEDERATIONS

(71) Applicant: DIGNITAS TECHNOLOGIES, LLC, ORLANDO, FL (US)

(72) Inventors: Robert Bruce Burch, Winter Springs, FL (US); Omar Syed Hasan, Orlando, FL (US); Jeffrey Lawrence Welch, Orlando, FL (US)

(21) Appl. No.: 18/920,464

(22) Filed: Oct. 18, 2024

Related U.S. Application Data
(60) Provisional application No. 63/639,818, filed on Apr. 29, 2024.

(51) Int. Cl. G06F 30/23; G06F 111/02

(52) U.S. Cl. CPC G06F 30/20; G06F 2111/02

(57) ABSTRACT

A computer-implemented process for coordination of model execution between federates within a simulation federation that includes receiving at a simulation server a modeling-capability advertisement for modeling of a real-world element and referencing a datastore that stores a plurality of modeling-capability registrations, where each modeling-capability registration includes a unique identifier that identifies a modeling computing component that can model a real-world element, a model type that indicates a type of the real-world element to be modeled, and a fidelity indicator that indicates a degree to which the modeling computing component can model the real-world element. The process may also include selecting a first modeling-capability registration based on the fidelity indicators in the plurality of modeling-capability registrations and delegating modeling control to the first federate, thereby enabling the first federate to facilitate a modeling of the real-word element in the simulation system.

### CROSS-REFERENCE TO RELATED APPLICATIONS

This Application claims the benefit of U.S. Provisional Application No. 63/639,818 (entitled FIDELITY-GOVERNED MODELLING SYSTEMS AND METHODS IN SIMULATION FEDERATIONS, having attorney docket no. 995-00003, and filed on Apr. 29, 2024), which is incorporated by reference herein for all purposes.

### BACKGROUND

Simulation environments help train people to perform better in real-world settings that are simulated by the simulation environment. The more accurately the simulation environment mirrors the real world, the more effective it is. Similarly, the more immersive the simulation environment is, the more effective is. Interrupting a simulation with external inputs (by training facilitators, for example) detracts from a simulation's effectiveness. This often happens when a simulation environment is unable to reflect a real-world condition. For example, say a group is being trained to respond to a tornado drill. As part of the training, the group needs to prepare for a scenario whereby local cellular service and internet access are unavailable. If the simulation environment has no way to disable the users' phones, a human being may have to intrude on the simulation and, for example, orally say “please now presume that you cannot use your phones to contact anyone.” That intrusion interrupts the simulation, diminishes the users' immersion in the training environment, and does not faithfully represent the real world.

Simulation environments are often composed of individual simulation systems (each referred to as a “federate”) that are networked together to form an organized collection (termed a “federation”). Each federate possesses unique functionality to model elements of the real world, and this functionality is contained within the federate as a set of “modeling capabilities”. Simulation federations are often referred to as distributed simulation environments since they are composed of computing resources distributed across multiple (possibly geographically dispersed) federate systems. Distributed simulation environments are often complex, consisting of many heterogenous federate systems. Alternatively, distributed simulation environments might be largely developed or based on one type of technology. Both scenarios present compatibility issues whereby coordinating the simulation execution across disparate types of systems is difficult, if not impossible (absent the present invention). Simulation systems focused on specific types of technologies are unable to be enriched with supplemental data modeled by other types of systems. For example, a certain simulation system might simulate the movement of vehicles well but have no knowledge of computers. Another simulation system might simulate computers well without a need or ability to present location (given that many computers do not change location). But consider a situation where computers are installed in vehicles, such as laptops to help police officer do their job. Enriching the vehicle-simulation system with a computer-simulation capability would be difficult if not impossible (absent the present invention).

Another shortcoming for the prior art is an inability to identify which federate should be allowed to model a real-life element (i.e., an object, effect, task, activity) within a simulation federation. Say a certain system has an ability to simulate the presence of an airplane but only in relatively vague terms, such as a geographic location and perhaps speed. But another system can more granularly simulate the present of an airplane down to type (jet versus propeller), sound, exhaust tail, speed, size, etc. If a given client requested that a plane simulation be presented, there is no way to know that the second system's simulation ability is superior and to allow that second system to present or control a plane simulation within a simulation federation.

A particular shortcoming of the state of the art is simulating cyberspace-related events, such as events related to cybersecurity, hacking, computer networks, communications, and the like. Cyberspace simulations are in on-going development, and (absent the present invention) there is no ability to coordinate the modeling of cyberspace objects and effects with the modeling within current simulations. For example, consider the vehicle-simulation scenario recited above. Absent the disclosed technology, it would not be feasible to enrich or supplement that simulation system to account for networking hacks or communications threats such as wirelessly commandeering the vehicle or accessing sensitive information.

If multiple federates within a federation possess the capability of modeling a set of tasks for an object, there is currently no way to automatically coordinate which federate should perform the modeling within the federation.

Additional shortcomings of the prior art are included in the detailed description below.

### BRIEF DESCRIPTION OF THE DRAWINGS

The present disclosure is described in detail below with reference to the accompanied drawing figures, wherein:

FIG. 1 depicts an illustrative computing environment suitable for practicing an embodiment of the disclosed technology;

FIG. 2 depicts an illustrative data flow in practicing an embodiment of the disclosed technology;

FIG. 3 depicts another illustrative data flow in practicing an embodiment of the disclosed technology;

FIG. 4 depicts another illustrative data flow in practicing an embodiment of the disclosed technology;

FIG. 5 depicts an illustrative computing environment suitable for practicing an embodiment of the disclosed technology;

FIG. 6 depicts an illustrative process in accordance with an embodiment of the disclosed technology;

FIG. 7 depicts an illustrative process in accordance with an embodiment of the disclosed technology; and

FIG. 8 depicts an illustrative architecture of computing devices used throughout this disclosure.

### DETAILED DESCRIPTION

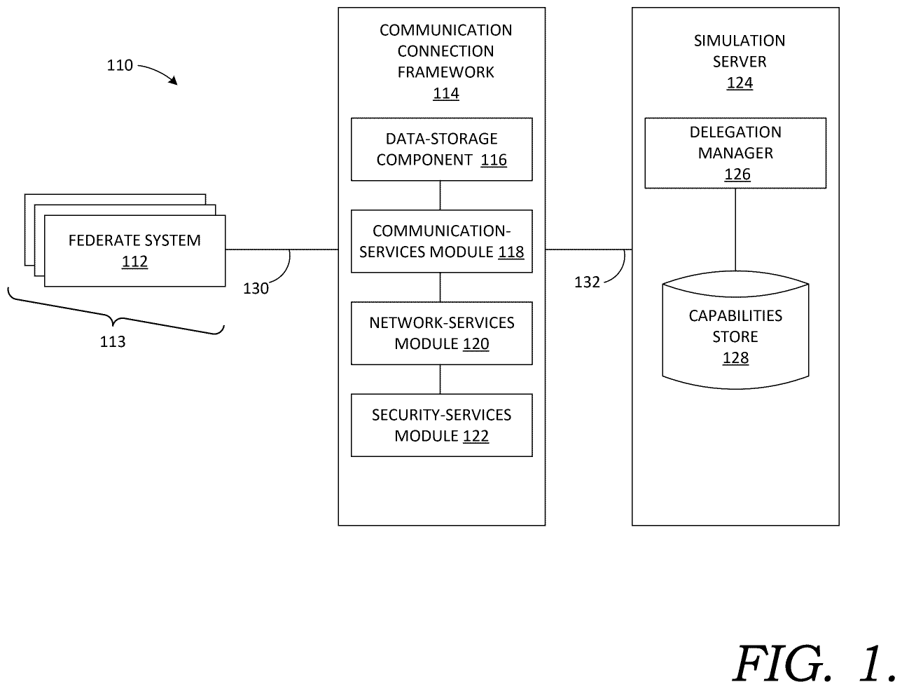

One application of the disclosed technology is to a collection of software systems that model physical and behavioral characteristics of real-world elements, such as vehicles, individuals, devices, organizations, terrain, weather, buildings, situations, environments, happenings, or any other occurrence that has or might occur in the real world. Such systems can be interconnected into a cooperating set of capabilities that include a larger sum-of-the parts capability. In one embodiment, federates 112 are federated into a federation 113 as illustratively depicted in FIG. 1, with an illustrative simulation environment referenced by numeral 110. In other embodiments, the federation is regarded as the environment 110; for example, including communication connection framework 114 and simulation server 124, which itself can be a federate 112.

The federation can include multiple federate simulation systems 112 that model an environment and its contents in a simultaneous fashion using discrete digital models to provide a real-life like replication of the environment, typically supporting analysis or training. Multiple federate systems 112 are shown. Each federate system can be different and/or can be more adept at modeling certain real-world elements better than others. The various connections, such as 130 and 132, as well as those not labeled, can be direct or indirect and through one or more networks, wireless or wired.

The federation uses a communication connection framework 114 to support communication of information between federate systems 112 according to a set of data representations and protocols. In one embodiment, communication connection framework 114 includes a data-storage component 116, a communication-services module 118, a network-services module 120, and a security-services module 122.

Data-storage component 116 provides an ability to store information over short or long term or to persist data. This helps the federation to be able to recall prior information during execution as well as save information that has been generated during the federation execution.

The communication-services module 118 supports the exchange of information between federates in a timely manner to support modeling of an environment in real-time. For example, actions in the models can be related to passage of time in the real world.

The network-services module 120 provides support for the use of the networking resource that connects multiple computational systems in a federation. This module provides interfaces and controls over the physical networking hardware to facilitate the communication-services module 118.

The security-services module 122 provides capabilities to help ensure the integrity and security of the execution and data in the federation. In one embodiment it can support the validation of the users or connected systems within a sensitive federation. In another embodiment it supports the secure exchange of information between different levels of security control in order to protect sensitive information.

Each federate system in the federation can model real-world elements, such as vehicles, individuals, and devices, using different mathematical approaches that can be referred to as levels of fidelity (e.g., how accurately the real-world aspects of a modeled component match the real-world). Along with fidelity, models may be characterized by their resolution, where resolution relates to how many of the real-world characteristics of a real-world element are modeled accurately (using the real-world as a benchmark for example).

Absent the disclosed technology, an issue in distributed simulation has been accounting for scenarios in which a common model causes effects (or is allowed to cause effects) across multiple federate systems with different levels of fidelity. For example, if a cyberspace effect is occurring (such as a Denial of Service or “DoS” effect), the mechanisms to model that effect can be vastly different within different federates. In the past, accounting for those differences has not been feasible. In addition, a federate may introduce a concept of a simulation effect that another federate has no representation for modeling—which the disclosed technology addresses but the prior art could not. Federations have suffered from an inability to utilize a common approach for coordinating the modeling of wide-reaching effects within the federation to ensure that interactions are accurate and fair across each federate. The disclosed technology meets this need.

The disclosed technology provides an approach for the characterization of simulation modeling capabilities, including cyberspace and other capabilities, in terms of the types of models supported and the level of fidelity of those models. The disclosed technology prescribes a data representation and content specification that is used to describe model fidelity in a quantifiable manner. Embodiments of the invention can accommodate varied definitions of levels of fidelity of models given that the variation in modeling approach is broad and varied. One embodiment contemplates a definition of an approach to define an ordinal level of fidelity in terms of model capability. For this embodiment, a higher fidelity capability refers to a more detailed modeling of a specified set of tasks than lower fidelities. Alternative embodiments might utilize, for example, an inverse approach or an approach based on words instead of numeric levels. Modeling capability can contain a fidelity attribute, which can include indicators such as ultra low, low, medium, high, ultra high, and the like or numeric values.

In one embodiment, each federate that joins the federation advertises (which can include providing a descriptive list of) its set of modeling capabilities, such as its models of cyberspace devices and effects. Although some of the description herein utilizes cyberspace as context or provides cyberspace-related examples, other embodiment of the disclosed technology outside of the cyberspace context are also applicable where context provides. Thus, examples related to cyberspace herein should not be read as limited only to cyberspace. And for readability, all instances of “cyberspace” may not be expressly qualified to mention “or other technological” instances, which are implied, and hereby made express.

Model data representations and content specifications are provided for cyberspace capabilities that include a characterization of the fidelity of its models and requirements of effects models. “Capability” can be generally thought of as an ability to model a set of tasks and to change the state of simulated objects represented within the simulation accordingly. Model capability data representations can include three functionalities in one embodiment. First, the model capability data characterizes the type of tasks simulated by the model (i.e., the purpose of this model). Second, the model capability data characterizes the applicability of the model (i.e., if the model is applicable only to certain types/classes of simulated objects or to any type). Third, the model capability data characterizes the fidelity of the simulated model (i.e., how closely the model represents the real world). The disclosed technology can use these characterizations of model capabilities and fidelities to ensure that a modeling request for a real-world element, such as an effect or task, is routed to an appropriate fidelity model to serve the requesting federate.

In the prior art, federates without the capability to model a particular real-world element, such as an effect or task, had no way to request that modeling from another federate within the federation and have the system delegate that request to a capable federate. The disclosed technology provides an approach to allow a federate to request modeling of a particular real-world element and have that modeling request delegated to the most appropriate federate within the federation to model that real-world element.

As mentioned, if multiple federates within the federation possess the capability of modeling a set of tasks for an object, there is currently no way to automatically coordinate which federate should perform the modeling within the federation. But the disclosed technology invention allows federates to advertise their modeling capabilities at a specific set of fidelities. In one embodiment, upon a need to perform modeling of a set of tasks for an object, an initiation of that modeling is automatically delegated to the federate with the highest advertised capability within the federation. This allows automated coordination across the federation of modeling capability, which, absent the disclosed technology has not been available.

The disclosed technology also provides an ability to support complex distributed simulation environments including analysis of alternatives studies, large scale student training, and cross-domain training events, all of which benefit from the ability to connect different types of systems (which can be federates) into a larger system of systems (which can be a federation). This sum-of-the-parts approach provides a greater capability by allowing modeling systems that target specific areas or disciplines to interact cooperatively.

In one embodiment, a combined federation supports complex analysis and/or training in that it efficiently models the complexities of multiple domains. The disclosed technology helps ensure that the system is capable of modeling an object or event at the highest level of fidelity tasked with that modeling when combining different systems in a common exercise. For example, two federates that model an object or event differently may not interact in a meaningful or correct way due to disparities in fidelity or resolution. The disclosed technology ensures that there are no disparities in the interaction between different approaches.

Absent the disclosed technology, legacy systems would have to be re-coded or implemented from the start, which is not feasible (if even possible). For example, the modeling and simulation industry has spent decades attempting to define the approaches for the interaction of physical objects in a given environment and still works to improve their interaction. With the recent introduction of cyberspace interactions and cyberspace-physical interactions, no prior system engineering and cooperation exists across federations. Instead, disparate cyberspace simulations and training environments (for example, cyberspace ranges) exist that do not have a well defined means of coordinating the modeling of cyberspace events and effects between them. The disclosed technology addresses this problem. It allows cyberspace simulations and training environments to advertise their cyberspace-related devices and effects at specific model fidelities. Coordination of modeling within the federation occurs so that delegation of cyberspace modeling to the appropriate model is facilitated. Cyberspace effects are provided to each system to interpret according to their modeling needs in one embodiment.

The disclosed technology provides an ability to coordinate the modeling activities of various federates within a federation based on their advertised modeling capabilities.

Three illustrative processes for the use of the modeling coordination approach are described (among others): advertisement of a modeling capability, registration of modeling capability, and invocation of a modeling capability.

In a first stage of an embodiment, each federate 112 in the federation 113 advertises 130 itself with a simulation server 124 by providing information about its models and simulated objects to the simulation server 124. This information includes simulated objects such as vehicles, lifeforms, and devices, for example, and information about the capabilities of any effect or task models that are provided by the federate. The model advertisement process includes creating and sending to the simulation server 124 modeling-capability advertisement instances that include information relative to the fidelity level of each advertised model in one embodiment.

A second aspect of an embodiment relates to management and storage of a unified representation of the advertised model capability data. This information is used by a delegation manager 126, a component of the simulation server 124, to ensure that a consistent representation of the modeling capabilities of each federate 112 in the federation 113 can be maintained in a capabilities store 128 for querying. In this stage, the simulation server 124 receives 132 modeling-capability advertisements from federates 112 in the federation 113 and creates a corresponding modeling-capability registration for each modeling-capability advertisement. The simulation server 124 stores each modeling-capability registration in capabilities store 128 to support its querying during federation execution.

A third aspect of an embodiment is active when, for example, the federation simulation is executing and either simulation federates or user interface federates request the modeling of real-world elements, such as a task or an effect. In this stage, federates 112 (either simulations or user interfaces) initiate a request for modeling of a real-world element, such as a cyberspace effect. This modeling request is sent to simulation server 124, which uses its delegation manager 126 to perform a delegation process to determine which federate should model the requested real-world element.

In one embodiment, during the delegation process, the delegation manager 126 queries a capabilities store 128 that contains the modeling-capability registration instances that were previously registered by all federates within the federation. The delegation manager 126 retrieves and examines the modeling-capability registrations contained in the capabilities store 128. For each returned modeling-capability registration (which could be, for example, a data object), it determines if that modeling capability is pertinent to the requested real-world element modeling task, using the modeling capability's advertised fidelity and model parameters in its determination. This can result in the selection of a single model or multiple models depending on the real-world element modeling request requirements. The delegation manager 126 obtains the unique identifier for any federate(s) to which the modeling request is delegated.

Delegation manager 126 issues the request to model the real-world element to the selected federate model(s). This modeling request is communicated to each selected federate and upon receipt, each federate models the requested real-world element, such as a cyberspace effect, using their internal modeling capability previously advertised.

### Federate Advertisement of Modeling Capabilities

This section focuses on an illustrative process that facilitates federates advertising their modeling capabilities to a federation. In one embodiment, federates send information to a simulation server to advertise their modeling capabilities. In another embodiment, the modeling capabilities of federates are ingested in other ways by the simulation server, such as by reading information from a file. In one embodiment, only federates that have advertised their modeling capabilities will be considered for delegation of modeling requests within the federation. Typically, federates advertise their modeling capabilities to the federation upon their initial connection to the federation. Modeling capabilities may be advertised for a variety of model types, such as models of vehicle mobility, weapon firing, weather, and cyberspace. Cyberspace model types may include modes of cyberspace effects, and models of cyberspace operational tactics, techniques, and procedures.

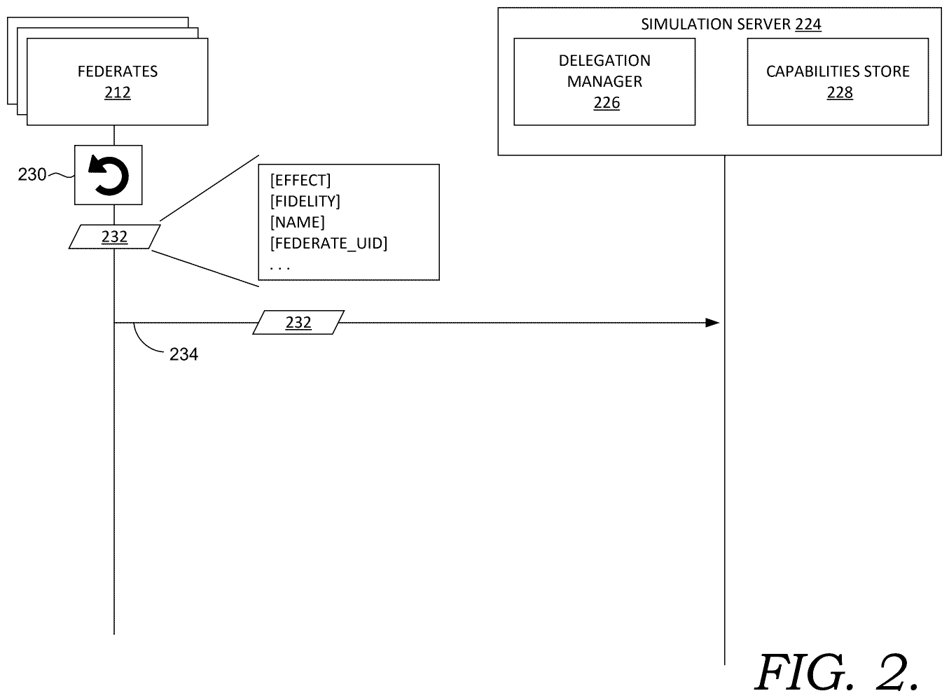

An illustrative process by which federates advertise their modeling capabilities is described herein with reference to FIG. 2, which includes one or more federate simulation systems (variously referred to as “federates” herein) 212 and simulation server 224 (which can include a delegation manager 226 and a capabilities store 228-and, as mentioned, could be a federate itself), with like numerals corresponding to like objects in FIG. 1. This example considers the advertisement of a modeling capability for a cyberspace effect, but advertisement of other modeling capabilities follows a similar pattern. At a step 230, a federate constructs a modeling-capability advertisement 232. For example, to advertise the capability to model a particular cyberspace effect, the federate constructs a cyberspace effect modeling-capability advertisement.

Within the modeling-capability advertisement 232, the federate specifies a particular real-world element, such as a task or effect, for which it has a modeling capability. In some embodiments (in cyberspace modelling, for example), illustrative effect models include areal jamming, black hole, CPU load, data exfiltration, data infiltration, delay of service, denial of service (DOS), eavesdropping, hardware damage, jamming, jitter, load rate, memory use, packet injection, packet manipulation, phishing effect, GPS jamming, distributed denial of service (DDoS), disruption, and the like.

The type of real-world element modeled by the federate can be selected from an enumerated list of strings in one embodiment, restricting federates from specifying random strings if desired. Embodiments of the technology to describe cyberspace effect models contemplate specifying the following illustrative cyberspace effect types within the modeling-capability advertisement: an aerial-jamming effect, a black-hole effect, a CPU-load effect, a data-exfiltration effect, a data-infiltration effect, a delay-of-service effect, a denial-of-service effect, an eavesdropping effect, a hardware-damage effect, a jamming effect, a jitter effect, a load-rate effect, a memory-use effect, a packet-injection effect, a packet-manipulation effect, a phishing effect, an unknown effect, a GPS-jamming effect, a distributed-denial-of-service effect, a disruption effect, and the like.

For advertisement of the capability to model a DoS cyberspace effect, for example, the federate could specify DENIAL_OF_SERVICE_EFFECT as the value of an EFFECT_TYPE within a cyberspace effect modeling-capabilities advertisement object.

Also, within the modeling-capability advertisement 232, the federate can specify a fidelity by which it is has a capability to model a particular cyberspace (or other) effect. For advertisement of the capability to model a DoS cyberspace effect as a medium level of fidelity, for example, the federate specifies a corresponding value of the FIDELITY within the cyberspace effect model capabilities advertisement object. The value could be a numerical value or string, such as “medium.” Thus, the modeling capability contains a fidelity attribute in one embodiment, which can be defined by values (ultra low, low, medium, high, ultra high, etc.), numbers, or other values. In some embodiments, the model creator is allowed to determine which value is correct for their model.

Also in the modeling-capability advertisement 232, a federate can specify a name by which its capability of modeling a real-world element, such as an effect or task, can be referred. This name can be selected from an enumerated list of strings in one embodiment, restricting client applications from specifying random strings if desired. For advertisement of a capability to model a DoS cyberspace effect as a medium level of fidelity (for example), the federate may specify the federate name concatenated to the cyberspace effect type as the value of the NAME attribute within the cyberspace effect modeling-capability advertisement.

The federate associates its unique identifier with the modeling-capability advertisement 232 in one embodiment. In one embodiment, when the federate creates the modeling-capability advertisement, that object is automatically stamped with the federate's unique identifier. When simulation server 224 receives the modeling-capability advertisement, it knows what federate it corresponds to because it contains the federate's unique identifier as an attribute of the modeling-capability advertisement. At a step 234, the federate communicates modeling-capability advertisement 232 to the simulation server 224.

### Registration of Federate Modeling Capabilities

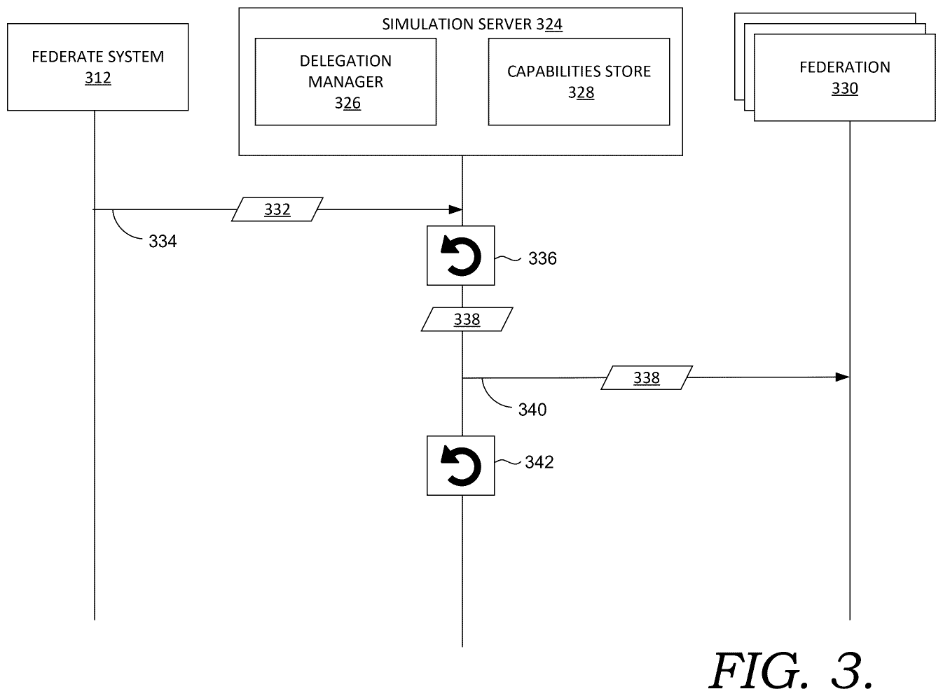

The previous section focused on an illustrative process by which federates advertise their modeling capabilities to a federation. This section focuses on a process by which those modeling-capability advertisements can be received and registered within the federation. Federate modeling capabilities are registered and stored within simulation server 124 for use during the delegation of modeling requests within the federation in one embodiment. One embodiment of a process by which simulation server registers federate modeling capabilities is described here with reference to FIG. 3, which includes a specific federate simulation system 312, a simulation server 324 (which can be a federate itself and can include a delegation manager 326 and a capabilities database 328), and other federates (with like numerals corresponding to like objects from other figures) within the federation 330. Although federation 330 is shown as block/set of blocks, that is for referential purposes. Federation 330 may include federate system 312, simulation server 324, and other federate systems. This example considers the registration of a modeling capability for a cyberspace effect model, but registration of other modeling capabilities follows a similar pattern.

At a step 334, modeling-capability advertisement 332 is received at simulation server 324. Simulation server 324 receives the modeling-capability advertisement 332 that was sent as described above in one embodiment.

At a step 336, a modeling-capability registration 338 is created by the simulation server. In one embodiment, simulation server 324 creates modeling-capability registration 338 based on attributes in the received modeling-capability advertisement 332. For a cyberspace effect modeling capability, simulation server 324 creates a cyberspace effect modeling-capability registration for example. Other modeling-capability registration types are created similarly for other model types. Modeling-capability registration 338 can include mandated fields and optional fields.

At a step 340, the modeling-capability registration 338 is sent to other federates within the federation 330 that should receive the registration. This may include sending the modeling-capability registration to all other federates or to selected federates. Simulation server 324 sends the created modeling-capability registration 338 to all federates in the federation 330 in one embodiment. This provides receiving federates with the ability to hold modeling capability data for other federates in the federation if desired. In another embodiment, simulation server 324 stores modeling-capability registrations to the file system.

At a step 342, the modeling-capability registration 338 is stored in capabilities store repository 328 in one embodiment. This allows querying of all known modeling capabilities within the federation to support delegation of modeling requests.

### Delegation of Modeling to Federates

The previous sections described illustrative processes by which federates 112 could advertise their modeling capabilities to a federation and by which those advertisements could be received and registered within the federation. This section discusses illustrative methods of how the registered modeling capabilities could be utilized when delegating modeling requests to federates within the federation.

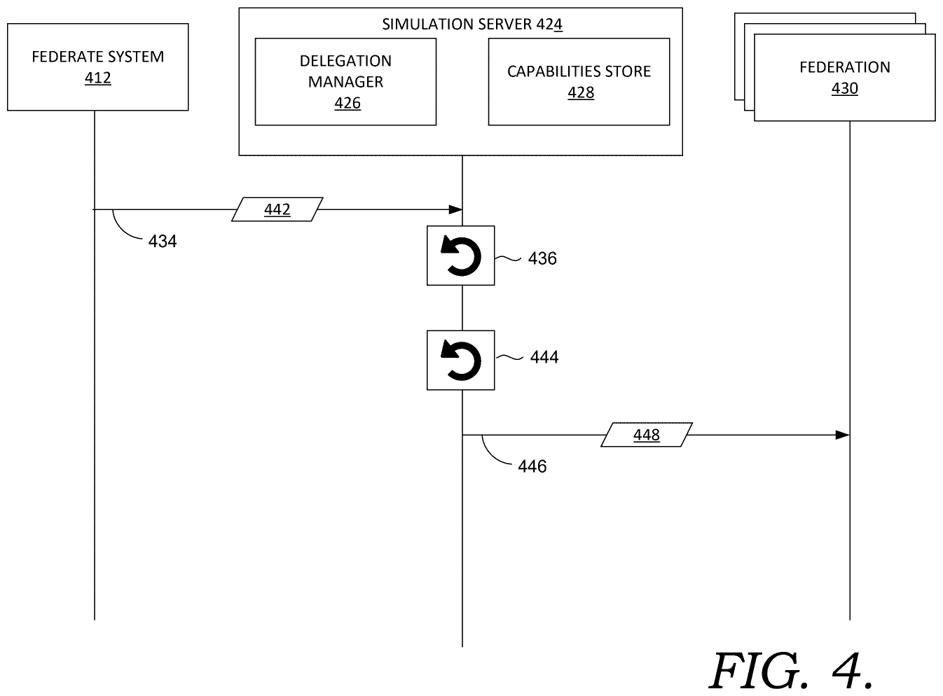

With reference to FIG. 4, a federate 412 sends a request 442 at a step 434 for the execution of a particular model of a real-world element, such as a task or effect. Federate 412 creates a modeling-request event 442 and sets attributes within that event to requesti modeling of the real-world element. For cyberspace effect modeling requests, for example, the federate creates a cyberspace effect modeling-request event. For other effects, different modeling types can be used in the modeling-request event.

The requesting federate 412 sends 434 the modeling-request event 442 to the simulation server 424. At a step 436, simulation server 424 references the capabilities store 428 to determine if any modeling-capability registrations have been previously registered for the requested modeling type. If modeling-capability registrations have been previously registered for the requested modeling type, simulation server 424 determines the object with the highest fidelity at a step 444. Simulation server 423 retrieves the unique identifier of the federate associated with the modeling-capability registration of the highest fidelity for the requested modeling type.

At a step 446, the selected modeling request 448 is sent to the appropriate modeling federate in federation 430. The modeling request is sent to the federate to perform the modeling of the real-world element, such as a task or effect. That federate begins execution of the requested model.

### Illustrative Process for Advertising Modeling Capabilities

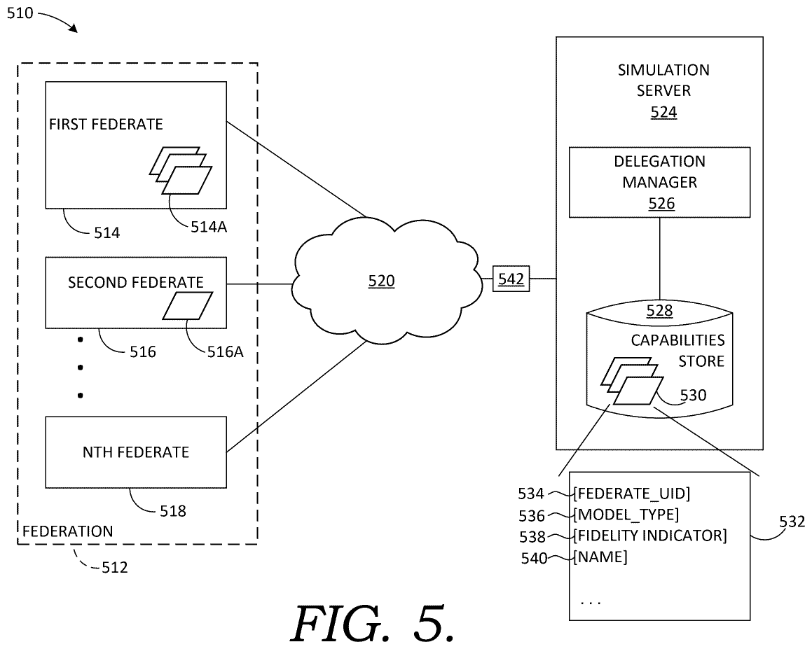

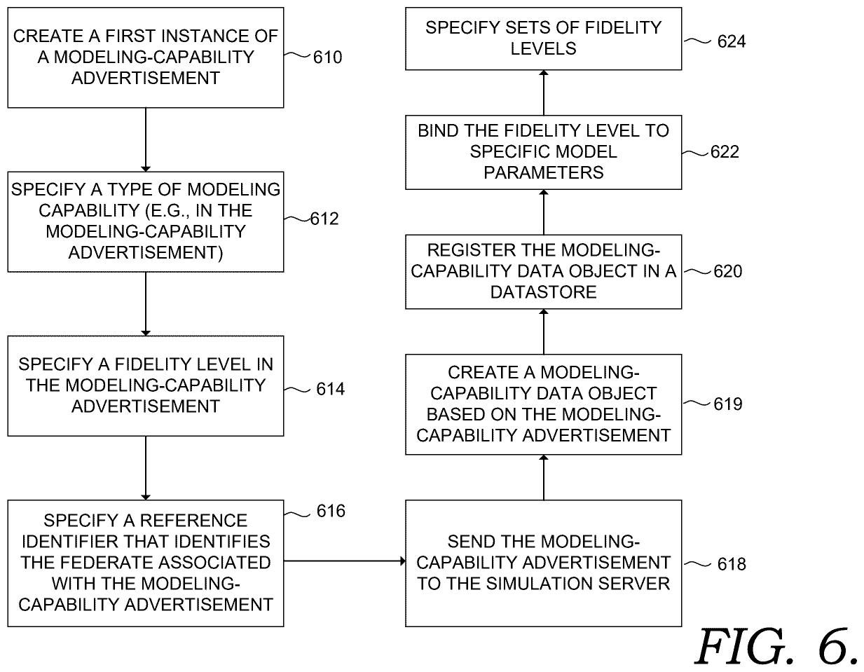

FIG. 6 depicts an illustrative process by which federates of a simulation system may advertise their modeling capabilities in accordance with an embodiment of the disclosed technology. Reference will also be made to illustrative components in FIG. 5. The process is facilitated by one or more non-transitory computer-storage media having computer-executable instructions embodied thereon that, when executed by a computing device, cause it to perform the method.

Step 610 can include creating a first instance of a modeling-capability advertisement in one embodiment. This could be carried out by simulation server 524 or any of the federates 514, 516, 518 (or others not shown) that make up a federation 512. An illustrative set of modeling-capability advertisements are indicated by reference numeral 514A. Similarly, numeral 516A indicates one or more illustrative modeling-capability advertisements, which could be present in all federates, though not expressly shown (for conciseness).

In one embodiment, a federate could provide information to simulation server 524, which creates a corresponding modeling-capability registration. In some embodiments, modeling-capability advertisement 514A includes several fields or parameters, such as a unique identifier 534 that identifies a federate (e.g., one or more of 514, 516, 518, 524) that can model a real-world element (i.e., task, effect), a model type 536 that indicates a type of the real-world element to be modeled, and a fidelity indicator 538 that indicates a degree to which the modeling-capability registration can model the real-world element. This could include a degree to which the modeling capability is accurate, e.g., accurately represents the real-word event and/or a degree to which it is precise, e.g., how specific or in what level of detail the modeling capability can represent the real-world element. It is not intended to make a discrete distinction between accuracy and precision per se in this disclosure. The modeling-capability advertisement 514A can also include a name identifier 540.

Step 612 can include specifying a type of modeling capability in the modeling-capability advertisement, which establishes a modeling type. The modeling type indicates of type of real-world element (e.g., item, situation, object, task, effect, scenario, process) that the modeling capability is to model. There are many different types of real-world elements that can be modeled. Several illustrative models were previously mentioned, ranging from a vehicle movement model, a weather model, and an aerial-jamming cyberspace effect model.

Step 614 includes specifying a fidelity level in the modeling-capability advertisement. The fidelity level indicates a degree to which the modeling capability is able to accurately or precisely model the modeling type. For example, one federate might be able to only simulate the presence of radio waves whereas another federate could simulate the presence of radio waves as well as specific radio-wave frequencies.

Step 616 includes specifying a reference identifier that identifies the federate advertising the modeling capability. In one embodiment, each modeling-capability advertisement is associated with a federate. The reference identifier identifies the federate for which the modeling-capability advertisement is associated.

Step 618 includes sending the modeling-capability advertisement to simulation server 524. Upon receipt of the modeling-capability advertisement, the simulation server 524 creates a corresponding modeling-capability registration at a step 619 that is stored at a step 620 in datastore 528 as a modeling-capability registration. In one embodiment, federate 514 communicates a modeling-capability advertisement 514A through one or more networks 520 to simulation server 524, which creates a corresponding modeling-capability registration from the modeling-capability advertisement. At step 620, the simulation server 524 stores the modeling-capability registration in capabilities store 528, thereby resulting in a set of stored modeling-capability registrations 530, which can be data objects for example. This enables simulation server 524 to select, when requested to provide a modeling service, the best modeling-capability registration, based on fidelity levels for example, upon a request from one or more of the federate simulation systems 514, 516, 518 to model the modeling type within the federation 512.

By way of example, first federate 514 issues the modeling-capability advertisement 514A to model the flight of planes at a medium level of fidelity via fidelity indicator 538. If no other federate (among 514-518 for example) has advertised a capability to model the flight of planes at a higher fidelity, then all modeling of plane flight will be handled by federate 514 when any federate requests a flying plane to be modeled in a simulation.

At a step 622, if desired, the fidelity level can be bound to specific model parameter values. This would facilitate the following scenario. First federate 514 issues the modeling-capability advertisement 514A to model the flight of specific type of plane (e.g., a Boeing 737) at a “medium” level of fidelity (or, say “5” out of “10”). This modeling capability only applies to the specific type of plane (e.g., Boeng 737 planes). If no other federate (514-518) has advertised a capability to model the flight of Boeing 737 planes at a higher fidelity, then all modeling of Boeing 737 plane flights will be handled by first federate 514's modeling capability advertised with the modeling-capability advertisement 514A.

At a step 624, if desired, sets of fidelity levels of the modeling-capability registrations could be specified. This would allow still more complicated or specific scenarios. For example, first federate 514 issues the modeling-capability advertisement 514A to model the flight of Boeing 737 planes at a “medium” level of fidelity and the capability to model the flight of Cessna planes at a “low” level of fidelity. This modeling capability 514A only applies to Boeing 737 planes and Cessna planes. If no other federate in federation 512 has advertised an ability to model the flight of Boeing 737 planes or Cessna planes at higher fidelities, than all modeling of Boeing 737 plane flights and Cessna plane flights will be handled by federate 514.

### Illustrative Process for Delegation of Modeling to Federates

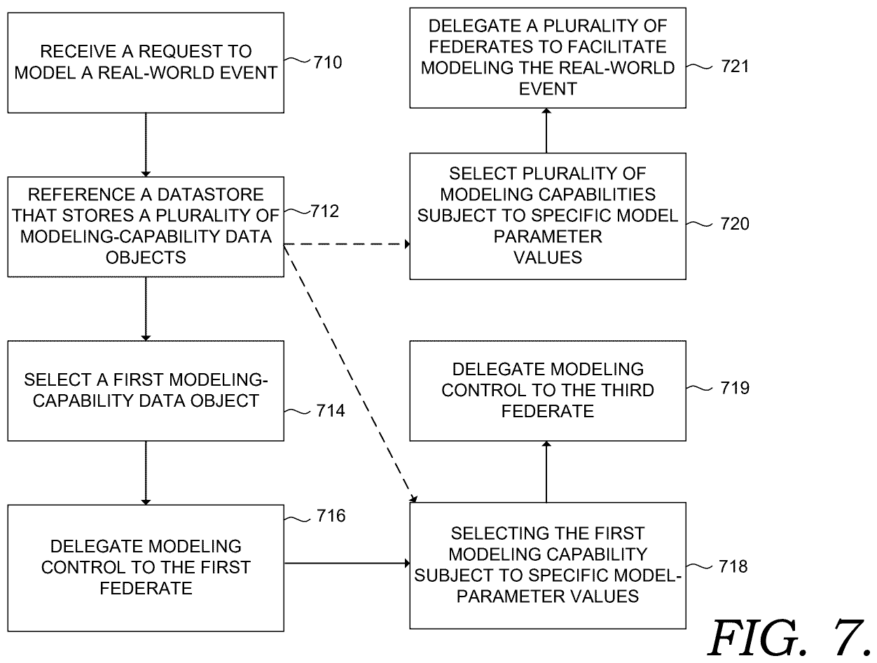

FIG. 7 depicts an illustrative process by which one or more federates are delegated the responsibility of performing the modeling of one or more real-world elements within a simulation environment. Reference will also be made to illustrative components in FIG. 5.

In a simulation environment 510, step 710 includes receiving a request 542 to model a real-world element, such as a task or effect. Request 542 is received by simulation server 524 in one embodiment. In one embodiment, request 542 is a request to have a real-world element modeled in a simulation system, such as among the federates in federation 512.

Step 712 includes referencing a datastore (such as capabilities store 530) that stores a plurality of modeling-capability registrations 530. In one embodiment, each modeling-capability registration is a data object that includes a unique identifier 534 that identifies a modeling computing component that can model a real-world element (such as an object, a scenario, an event, a task, an effect, an environment, a process, or combinations thereof). The modeling computing component (e.g., 514) is among a plurality of modeling computing components (federates) that make up a federation, such as federation 512. Each modeling-capability registration could also include a model type 536 that indicates a type of the real-world element to be modeled, examples of which have been previously provided. Each modeling-capability registration could also include a fidelity indicator 538 that indicates a degree to which the modeling federate can model the real-world element.

Step 714 includes, based on the fidelity indicators in the plurality of modeling-capability registrations, selecting a first modeling-capability registration. In one embodiment, modeling-capability registrations are selected from data objects stored within a capabilities store 530. Thus, for example, if there are five modeling-capability registrations among the set of data objects within capabilities store 530 that can model a cyberspace event (or other real-world scenario), the one with the highest fidelity would be selected at this step in one embodiment. The first modeling-capability registration is associated with a first federate (e.g., any of 514, 516, or 518) by way of the first modeling-capability registration's corresponding federate unique identifier 534.

Step 716 can include delegating modeling control to the first federate (e.g., 516), thereby enabling the first federate to model the real-word element in the simulation system utilizing the modeling capability described in its modeling-capability advertisement 516A. Federate 516 is the federate that simulation server 524 would delegate modeling of the requested task or effect throughout the federation in one embodiment.

In operation, by way of example, second federate 516 requests modeling of a flight of planes. Simulation server 524 determines that first federate 514 has registered the capability to model the flight of planes at a “medium” level of fidelity. If no other federates among those in federation 512 have registered an ability to model the flight of planes at a higher fidelity, then all modeling of plane flight in federation 512 will be delegated to first federate 514 (e.g., using the model among the set of models within federate 514 that corresponds to modeling the flight of planes).

As an alternative to step 714, an embodiment could continue to step 718, which could include selecting the first modeling-capability registration subject to specific model-parameter values. An example that employs this step follows. Second federate 516 could request modeling of the flight of Boeing 737 planes. Simulation server 524 determines that first federate 514 has registered the capability to model the flight of planes at a medium level of fidelity. The system determines that third federate 518 has registered the capability to model the flight of Boeing 737 planes at a medium level of fidelity. Since no other model has registered the ability to model the flight of Boeing 737 planes at a higher fidelity, and because first federate 514 used a more general model registration method that did not specify the type of plane, all modeling of Boeing 737 plane flight will be delegated 719 to third federate 518.

As an alternative to step 714, an embodiment could continue to step 720, which could include delegating a plurality of federates to facilitate modeling the real-world element. This would contemplate the following scenario. Third federate 518 requests modeling the flight of Cessna and Boeing 737 planes. Simulation server 524 determines that first federate 514 has registered the capability to model the flight of Cesna planes at a medium level of fidelity. The simulation server determines that second federate 516 has registered the capability to model the flight of Boeing 737 planes at a medium level of fidelity and the capability to model the flight of Cessna planes at low fidelity. If no other model has registered the ability to model the flight of Cessna planes and Boeing 737 planes at higher fidelities, all modeling of Cessna plane flight will be delegated 721 to first federate 514 and all modeling of Boeing 737 planes will be delegated 721 to second federate 516.

As explained, simulation server 524 receives a modeling-capability advertisement that includes (1) a type of modeling capability that indicates of type of real-world element modeled by this modeling capability, (2) a fidelity level that indicates a degree to which the modeling capability can model the real-world element; (3) a reference identifier that identifies a first federate associated with the modeling-capability advertisement, wherein the first federate is within a plurality of federates that make up federation 512. The process of this embodiment further includes storing the modeling-capability registration in capabilities database 530, thereby enabling simulation server 524 to select the modeling-capability registration (among those in 530) based in its fidelity level upon a request 542 from one or more federates. The method could also include selecting the federate associated with the modeling-capability registration to model the real-world element in at least a portion of the federation.

### Examples

This section provides various examples of technological applications of the disclosed technology.

Three federates (instances of systems 112) each have a modeling capability to model rain. One is only binary in nature, indicating that there is rain or there is not. Its modeling fidelity is “2.” A second system can further indicate rain direction. Its modeling fidelity is “4.” A third system can further model a rate and quantity of rainfall. Its modeling fidelity is “8.” All three federates register their ability to model rain and their respective fidelities with simulation server 124, which stores them in capabilities store 128. When a specific federate (instance of 112) requests that rain be modeled, the request is received by simulation server 124, which references capabilities store 128, selects the third system, based on it having the highest fidelity level for that modeling type, and then utilizes delegation manager 126 to delegate the modeling responsibility to the third system. The third system is allowed to model rainfall for the full federation 113.

Three federates (instances of systems 112) can each model a cell tower. One is only binary in nature, indicating that radio signals are emitted or not. Its modeling fidelity is “2.” A second system can further model three different radio-wave frequencies. Its modeling fidelity is “4.” A third system can further model intentional intermitted errors or brief periods of no emissions. Its modeling fidelity is “8.” All three federates register their ability to model a cell tower and their respective fidelities with simulation server 124, which stores them in capabilities store 128. When a specific federate (instance of 112) requests that cell towers be modeled, the request is received by simulation server 124, which references capabilities store 128, selects the third system, based it having the highest fidelity level for that modeling type, and then utilizes delegation manager 126 to delegate the modeling responsibility to the third system. The third system is allowed to model one or more cell towers for the full federation 111.

### Illustrative Computing Devices

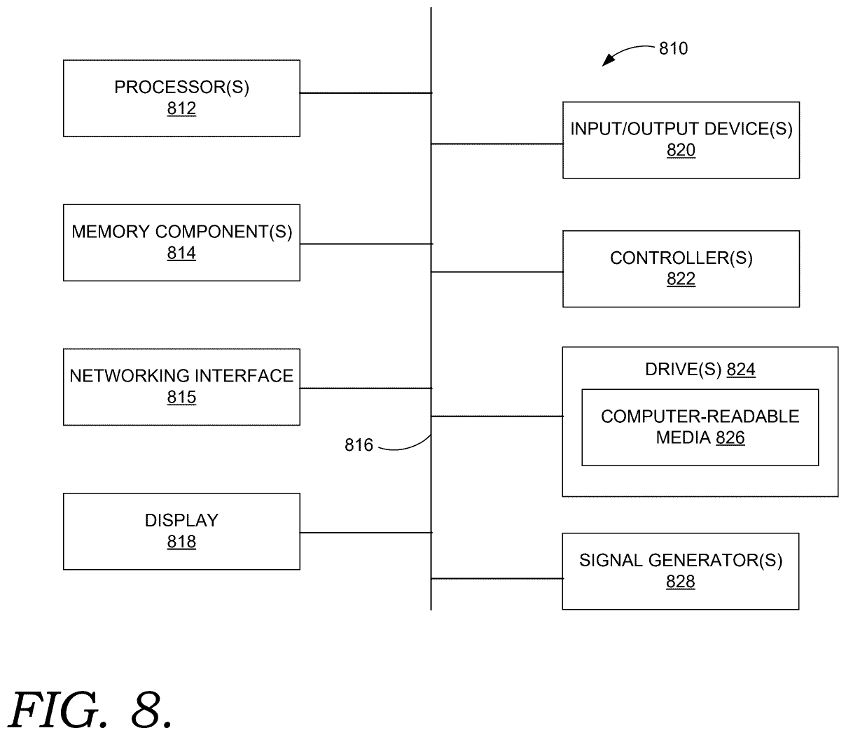

FIG. 8 depicts an illustrative computing system 810 where at least some operations described in this disclosure may be implemented. Computing system 810 can include one or more processors 812, memory components 814 (which can include non-volatile or volatile) memory, one or more network interfaces 815, one or more video display devices 818, input/output devices 820, control devices 822 (e.g., a keyboard, touchscreen, mouse, pen, etc.), one or more drives 824 (such as hard drives, solid-state drives, etc.), which can include one more storage medium 826 (such as computer-readable storage media), and one or more signal generators 828 that are directly or indirectly coupled to each other by way of a bus 816. Bus 816 can be multiple physical buses or direct connections that are connected by bridges, adapters, controllers, and the like. Various components (e.g., cache and other types of memory) are not depicted but are contemplated as applicable. Computer system 810 depicts illustrative hardware on which components illustrated or described by way of the included examples of the figures and any other components described in this specification may be implemented.

Computer system 810 may assume a variety of physical forms. For example, computing system 810 may share a similar architecture as that of a server computer, personal computer (PC), tablet, smartphone, augmented reality (AR)/virtual reality (VR) systems, or other types of electronic devices that are capable of executing sets of instructions that specify actions to be taken by a computing system. Computing system 810 could be an embedded computer system or a distributed system such as a mesh of computer systems or include cloud components coupled by way of one or more networks.

Network interface device 815 facilitates computing system 810 communicating data by way of a wired network, wireless network, peer-to-peer network 814, or other computing devices outside of computing system 810. Various protocols are contemplated. Network interface device 815 may include a network-adaptor card, a wireless-network interface, a router (wired or wireless), an access point, a switch, a protocol converter, a gateway, a bridge, bridge router, a hub, a repeater, or other types of devices.

Memory components 814 can be local, remote, or distributed. Computer-readable storage media 826 can include multiple types of media, such as centralized or distributed databases, caches, servers, etc.) that store instruction sets. Computer-readable storage media 826 can include any medium that is capable of storing, encoding, or carrying a set of instructions for execution by computing system 810, but does not include mere signals per se. Media 826 can be non-transitory or comprise a non-transitory device. A non-transitory storage medium includes tangible devices, meaning that the device has a concrete physical form, although the device can change its state. Thus, for example, non-transitory refers to a device remaining tangible despite a change in state.

Although disclosed embodiments have been described in the context of fully functioning computing devices, the examples described herein may be distributed as an embodied program product in multiple forms. Examples of machine-readable storage media include recordable-type media such as volatile and non-volatile memory devices, flash-memory devices, hard drives, thumb drives, solid-state components, optical discs, and the like.

Routines may be executed to implement examples described herein and can be implemented as part of an operating system. They may also be implemented via a specific application, component, or program, as well as an object, module, or sequence of instructions (all collectively referred to as “computer programs”). Computer programs can include instructions at various times in various memory and storage devices in computing devices. When read and executed by one or more processors 812, the instructions cause computing system 810 to perform operations to execute elements involving the various aspects of the disclosure.

The various severs, computing devices, computers, computing components and similar components described herein may assume the high-level form of computing device 810.

### Confirmations

In this disclosure, including the drawings, some objects, items, or steps have been referenced in the singular or are depicted as one item. But those references and depictions equally represent multiple, instead of singular, objects. For example, simulation server 124 is depicted by a rectangle that could represent multiple servers, as is the case with the various other computing devices described herein. Moreover, the connections may be multiple connections, direct or indirect, and include various components that are not depicted, generally for readability.

Unless context clearly requires otherwise, throughout the description and the claims, the words “comprise,” “comprising,” “including,” and the like are to be construed in a non-exhaustive sense, such as “including, but not limited to.” Terms such as “connected,” “coupled,” or variants thereof mean any connection or coupling, either direct or indirect, between two or more elements. The coupling or connection between the elements can be physical, logical, or a combination thereof. Additionally, words such as “herein,” “above,” “below,” and words of similar import may refer to this application as a whole and not to any particular portion of this application. Where context permits, words in the above description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to embodied software components, firmware components, or hardware components.

Many different arrangements of the items depicted (or not depicted) are feasible without departing from the scope of the claims that follow. Embodiments of the disclosed technology have been disclosed herein as illustrative (not restrictive). Alternative embodiments will become apparent to readers of this disclosure upon reading it. Alternative means of implementing the disclosed embodiments may be completed without departing from the scope of the claims. Some features and sub-combinations have utility and may be employed without reference to other features and sub-combinations. They too are contemplated within the scope of the claims.

Although the disclosed subject matter has been described in language related to structural features and/or acts, the subject matter claimed in the claims is not necessarily limited to the specific features or acts described above. Rather, the specific features and acts described are disclosed as examples of implementing the claims. Other equivalent features and acts are intended to be within the scope of the claims.

What is claimed is:

1. One or more non-transitory computer-storage media having computer-executable instructions embodied thereon that, when executed by one or more processors of a system, cause the system to perform a method, the method comprising:
generating a first instance of a modeling-capability advertisement;
specifying a type of modeling capability in the modeling-capability advertisement, thereby establishing a modeling type, wherein the modeling type indicates a type of real-world element that a simulation system is able to model;
specifying a fidelity level in the modeling-capability advertisement, wherein the fidelity level indicates a degree to which the simulation system is able to accurately model the real-world element;
specifying a reference identifier in the modeling-capability advertisement that identifies the simulation system within a simulation environment.

2. The media of claim 1, wherein the real-world element is an object, a task, an activity, an effect, a scenario, an event, an environment, a process, or combinations thereof.

3. The media of claim 1, further comprising communicating the modeling-capability advertisement to a simulation server that is coupled to the simulation system and a capabilities datastore, thereby enabling the simulation server to facilitate storage of modeling-capabilities information, wherein the modeling-capabilities information is information about the modeling capabilities of the simulation system.

4. The media of claim 3, where in communicating the modeling-capability advertisement includes communication via a file system, thereby enabling the simulation server to store information about the modeling capabilities of the simulation systems in the datastore.

5. The media of claim 1, wherein the fidelity level is bound to specific model-parameter values.

6. The media of claim 1 further comprising specifying sets of fidelity levels of the modeling capability, wherein each fidelity-level set is bound by specific model parameter values.

7. The media of claim 5, wherein the model-parameter values include one or more of the following: a type of object, a class of object, a geographic region, and a time of day.

8. The media of claim 1, wherein the type of modeling capability models one or more of the following effects: an aerial-jamming effect, a black-hole effect, a CPU-load effect, a data-exfiltration effect, a data-infiltration effect, a delay-of-service effect, a denial-of-service effect, an eavesdropping effect, a hardware-damage effect, a jamming effect, a jitter effect, a load-rate effect, a memory-use effect, a packet-injection effect, a packet-manipulation effect, a phishing effect, a GPS-jamming effect, a distributed-denial-of-service effect, or a disruption effect.

9. One or more non-transitory computer-storage media having computer-executable instructions embodied thereon that, when executed by a computing device, cause the computing device to perform a method, the method comprising:
at a simulation server, receiving a modeling-capability advertisement for a modeling computing component that includes (1) a type of modeling capability that indicates of type of real-world element that the modeling computing component is able to model, (2) a fidelity level that indicates a degree to which the modeling computing component is able to model the real-world element; (3) a reference identifier that identifies a first federate associated with the modeling-capability advertisement, wherein the first federate is within a plurality of federates that make up a federation; and
storing the modeling-capability advertisement by creating a corresponding modeling-capability registration in a capabilities database, thereby enabling the simulation server to select the modeling-capability registration based in its fidelity level upon a request from one or more federates.

10. One or more non-transitory computer-storage media having computer-executable instructions embodied thereon that, when executed by a computing device, cause the computing device to perform a method, the method comprising:
in a simulation environment, receiving at a simulation server a request to model a real-world element;
referencing a datastore that stores a plurality of modeling-capability registrations, wherein each modeling-capability registration includes (1) a unique identifier that identifies a modeling computing component that is able to model a real-world element, wherein the modeling computing component is among a plurality of modeling computing components that make up a federation; (2) a model type that indicates a type of the real-world element to be modeled; and (3) a fidelity indicator that indicates a degree to which the modeling computing component is able to model the real-world element;
based on the fidelity indicators in the plurality of modeling-capability registrations, selecting a first modeling-capability registration, wherein the first modeling-capability registration is associated with a first federate by way of the first modeling-capability registration's corresponding unique identifier; and
delegating modeling control to the first federate, thereby enabling the first federate to facilitate a modeling of the real-word element in the simulation system.

11. The media of claim 10, wherein the model type corresponds to one or more of the following effects: an aerial-jamming effect, a black-hole effect, a CPU-load effect, a data-exfiltration effect, a data-infiltration effect, a delay-of-service effect, a denial-of-service effect, an eavesdropping effect, a hardware-damage effect, a jamming effect, a jitter effect, a load-rate effect, a memory-use effect, a packet-injection effect, a packet-manipulation effect, a phishing effect, a GPS-jamming effect, a distributed-denial-of-service effect, or a disruption effect.

12. The media of claim 10, wherein selecting the first modeling-capability registration is done subject to specific model-parameter values.

13. The media of claim 10, wherein delegating the modeling control includes delegating a plurality of federates to facilitate modeling of the real-world element.

14. The media of claim 10, wherein delegating modeling control includes informing all of the plurality of modeling computing components, such that the federation is aware of which federate will facilitate modeling the real-world element.
